(19) United States
(12) Patent Application Publication
(10) Pub. No.: US 2024/0301710 A1
(43) Pub. Date: Sep. 12, 2024

(54) SYSTEM AND METHOD FOR STRUCTURE LIFTING

(71) Applicant: FS MANUFAB INC., Regina, Saskatchewan (CA)

(72) Inventors: Monty Wensel, Regina (CA); Eric Jonasson, Powell River (CA); Shawn Christopher Fulton, Regina (CA)

(21) Appl. No.: 18/276,388

(22) PCT Filed: Feb. 6, 2022
(86) PCT No.: PCT/CA2022/050168

§ 371 Date: Aug. 8, 2023

(30) Foreign Application Priority Data
Feb. 8, 2021 (CA) 3108365

(51) Int. Cl. E04G 23/06; B66F 7/14

(52) U.S. Cl. CPC E04G 23/065; B66F 7/14

(57) ABSTRACT

A lifting tower for use in the adjustment of the height of an attached structure. The tower uses rotational power means to raise and lower a lift, and an attached lifting beam, within the entire travel zone defined by vertical columns of the tower in a single stroke without the need for any intermediate recalibration of the tower. A system comprising a plurality of towers and a controller, as well as a method of use, are also disclosed.

This invention is in the field of building maintenance and lifting applications, and more specifically discloses a structure lifting tower and a system of towers for use in the lifting of a building structure using a plurality of lifting beams.

### BACKGROUND

Lifting and moving buildings is a construction tactic used for many years. In its most traditional sense, lifting and moving buildings typically comprised the insertion of a plurality of lifting beams underneath a building to be lifted, and then using hydraulic jacks and blocks to lift the building sufficiently high to allow for the manipulation of a moving trailer thereunder.

One of the primary problems with the traditional building lifting approach of using a hydraulic jack and blocks under the ends of a plurality of lifting beams is that it is dangerous and physically demanding, insofar as the jack and blocking approach requires constant jacking, insertion of blocks etc., and the use of multiple manual jacks at corners of the building in sequential order to maintain approximate level on the building as it is lifted. As the building is raised, it is potentially necessary to “reset” the jacks and put blocks underneath them as their stroke length is reached—creating further physical labour demands. Using jacks and blocks is also dangerous, since it is possible for the blocking to move or shift, and in a worst case scenario a corner of the building can fall.

If it were possible to provide a means of building lifting to a higher height it might provide better ability to work under a building without the need to move the structure—but lifting buildings to a higher height using jacks and blocks is simply too unsafe for practical and reasonable commercial use.

Many attempts have been made in the building moving industry to come up with safer and simplified methods of building lifting. These have typically focused on the use of hydraulic jacks with longer strokes to decrease the number of resets required for each jack where a building needs to be lifted to a high height.

Other attempts in the prior art have centered around provision of a tower based lifting system. For example, Canadian Patent Ser. No. 2816482 to Wensel discloses a tower-based lifting system. The tower disclosed in that document discloses a means of safety-enhanced higher lifting, but still relies upon the need to conduct interim resets on the jacking equipment during a building lift. Thus while safety is enhanced with the use of the '482 device the need for continued jack resets in a building lift creates delay, and the towers in that case require the use of removeable safety locks or anchors to anchor the building in place and hold in position at lift height. If it were possible to provide a tower based lifting system that removed the need for interim equipment resets during the full lifting stroke length of the tower, and provide a mechanism that retained the building at lift height safely without the need for attachment and detachment of retaining anchors, this would be commercially desirable.

### SUMMARY OF THE INVENTION

The first embodiment of the invention comprises a lifting tower for use in the adjustment of the height of an attached structure. The lifting tower includes a ground engaging base which will provide ground support for the tower and any attached structure, as well as maintaining the vertical orientation of the lifting tower in a particular position on the ground.

The key tower elements comprise a left column having a base end and a top end as well as a right column having a base and a top end. The base end of both the left column and the right column are attached to the ground engaging base and extend upwards therefrom. The right column is attached and positioned on the base such that it extends upwards and parallel to the left column so that the left column and the right column define a travel zone between them and therealong extending from the base to the top ends.

A threaded left lifting rod of at least the same length as the left column is rotatably attached in parallel axial relation to the left column. A threaded right lifting rod of at least the same length as the right column is rotatably attached in parallel axial relation to the right column. The threaded left and right lifting rods will provide in conjunction with other components the ability to lift the structure in relation to the travel zone defined by the left and right columns.

A travelling lift will be positioned between and engage the left and right columns and is capable of travel therealong within the travel zone. The body of the travelling lift will engage the left and right columns in a way that it can slide there along, in the axial direction of the columns extending upwards from the base. The body of the travelling lift includes a left column engagement means, engaging the travelling lift in relation to the left column and comprising a left threaded collar aligned parallel to the base. The left threaded collar defines a threaded aperture therethrough which can engage the left threaded rod. A mirrored right column engagement means engages the right column and comprises a right threaded collar aligned parallel to the base with a threaded aperture for engagement of the right threaded rod extending therethrough. The lift also comprises an engagement interface for attachment of the body of the lift to an engagement point of the structure, by which tower generated vertical movement would be applied to the structure.

The final element of the tower is a bidirectional rotational power means for application of mirrored rotational power to the left and right lifting rods. The bidirectional rotational power means will provide mirrored rotational power by comprising two separate motors or power means controlled in conjunction with each other, or might comprise a single bidirectional rotational power means such as a motor or the like with the necessary gearing, driveshaft and the like for one motor to engage and provide rotational power to both left and right threaded lifting rods. Both such approaches are contemplated within the scope of the present invention.

In operation of the tower, actuation of the rotational power means will result in the application of lifting or lowering force to the lift as well as to any engaged structure. The rotational power means is locked when not actuated, eliminating gravitational movement of the lift or the structure engaged. Locking of the rotational power means might be achieved by incorporation of the physical locking mechanism, or simply by virtue of the fact that there is no ability for the rotational power means to move in reverse without actuation. Both such approaches again are contemplated within the scope of the present invention.

The lifting tower represents multiple advantages over the prior art, one of the primary elements of which is that the lift element of the tower can travel within the entire travel zone defined by the columns in a single stroke without the need for any intermediate recalibration of the tower. Effectively, the rotational power means will rotate the left and right lifting rods when it is desired to lift or lower the attached structure and those rods in conjunction with their corresponding threaded collars/apertures will result in the application of a rotationally actuated lifting or lowering motion on the travelling lift of the tower.

In most embodiments the lifting tower would also include an upper terminating member used to join the top ends of the left and right columns, which would maintain the parallel spacing of the columns and the width of the travel zone. The rotational power means could comprise different apparatus for achieving the desired application of rotational lifting or lowering motion. In some embodiments of the lifting tower of the present invention the rotational power means might comprise left and right motors attached in relation to the left and right threaded rods and having mirrored control. In other embodiments of the invention, the rotational power means of the lifting tower would comprise a single motor with a means of providing mirrored rotational power from the single motor to both the left and right threaded rods. The use of a single motor or multiple motors with joint control will both be understood to be within the scope of the present invention.

Many different types of engagement interfaces could be used with the lifting tower to achieve the ability to apply a lifting or lowering force to an engagement point of a structure in accordance with the remainder of the invention. It is specifically contemplated that the engagement interface of the lift of the lifting tower could comprise a saddle for engagement of a lifting beam placed underneath the structure, as would typically be used in conventional building lifting applications. The engagement interface could also comprise different types of attachment hardware for engagement to a structural engagement point of the structure itself, and both such approaches are contemplated within the scope of the present invention.

The rotational power means of the lifting tower could be located at the top end of the tower, or at the base of the tower. Either approach will be understood to be within the scope of the present invention.

The lifting tower could be of a fixed height, or could be adjustable in height by making the left and right columns comprise nested telescoping sections with the necessary additional lifting means to permit the mirrored adjustment of the length of the left and right columns. In a case where the lifting tower comprised telescoping sections for the left and right columns, powered extension means to mechanically telescope the length of the columns without the need for detachment of the tower from the structure would be a key element. By providing embodiments of the lifting tower of the present invention with left and right columns that telescope or were otherwise adjustable in length, the lifting height of the tower is extensible and allows for the manufacture of the lifting tower in accordance with the invention that could lift to building higher without the need for any detachment of the tower from the structure to extend the length of the tower therefrom.

Present invention also accomplishes its objectives comprising a system for use in the lifting of the structure, by applying a lifting force to a plurality of engagement points of the structure. The system comprises first a plurality of lifting towers in accordance with the present invention, a lifting tower corresponding to each of the number of engagement points of the structure which lifting or lowering forces to be applied. Each lifting tower comprises a vertical tower body, lift for engagement of a corresponding engagement point of the structure and being attached to the vertical tower body for vertical movement within a travel zone defined by the tower body. The lift can travel within the entire travel zone in a single stroke without the need for any intermediate calibration of the tower. Finally the tower also includes power means capable of applying lifting or lowering movement to the lift when actuated and being locked to restrict gravitational movement of the lift when not actuated.

In addition to the plurality of lifting towers, the system also includes a controller connected to the power means of each lifting tower, and capable of controlling the lifting movement applied to the structure by each tower by selectively actuating the power means of each tower.

As outlined above, the lifting towers of the system of the present invention could be any embodiment of a lifting tower in accordance with the present invention including lifting towers of a fixed height, or lifting towers which are adjustable in height. The lifting towers being adjustable in height would likely be telescoping in nature—the same type of modifications which would allow for adjustable height lifting towers as are outlined herein with respect to the lifting tower aspects of the invention will be understood to be applicable to the lifting towers used in the system as well.

The lifting towers used in accordance with the system as outlined, where adjustable in height, could be telescoping in nature with the necessary and attendant modifications to the drive and rotational power system. For example where a telescoping lifting tower was used as a part of the system, each of the columns of the tower might comprise nested column sections, with the threaded left and right lifting rods being sized and attached, and the travelling lift positioned in relation to, the innermost problem sections and additional breaded lifting rods or required equipment being provided to permit for the mirrored extension or retraction of the nested column sections in relation to each other to effectively extend the single stroke length of the travel zone.

The method of the present invention as is also disclosed comprises a method of lifting of a structure by applying lifting force to a plurality of engagement points of the structure. The method comprises positioning a plurality of lifting towers in accordance with the present invention each to an engagement point of the structure to which lifting or lowering forces to be applied. Following the connection of the plurality of lifting towers to engage a corresponding plurality of engagement points of the structure, a controller will be connected to the power means of each lifting tower, capable of independently controlling the lifting movement applied to the structure by each tower. The controller will then be used to actuate the power means of one or more of the towers to lift the structure to the desired height. The lifting towers could be any tower in accordance with the remainder the present invention including those of a fixed height, or those which are adjustable or telescoping in height.

The method of the present invention could comprise the engagement or lifting of the structure having a plurality of lifting beams temporarily installed there under to permit for lifting of same. In such a case, the engagement interfaces of the lifting towers would comprise saddles capable of engaging the beams, and the engagement points of the structure are surfaces of the beams engaging the saddles.

### DESCRIPTION OF THE DRAWINGS

To easily identify the discussion of any particular element or act, the most significant digit or digits in a reference number refer to the figure number in which that element is first introduced. The drawings enclosed are:

FIG. 1 is a perspective view of a lifting tower in accordance with one embodiment of the invention;

FIG. 2 is a detail view of the lifting mechanism of the embodiment of FIG. 1;

FIG. 3 is a perspective view of an alternate embodiment of a telescoping lifting tower in accordance with the invention;

FIG. 4 is a schematic diagram showing the components of one embodiment of a system in accordance with the invention;

FIG. 5 is a side view of the system of FIG. 4 showing the lifting of the engaged structure with two fixed length towers being shown;

FIG. 5A is a side view of the system of FIG. 4 showing the lifting of the engaged structure with two telescoping length towers being used,

FIG. 6 is a flowchart showing the steps in one embodiment of a method in accordance with the invention.

### DETAILED DESCRIPTION OF ILLUSTRATED EMBODIMENTS

As outlined herein, the present invention comprises a system and method for use in the adjustment of the height of an attached structure—for use in building lifting and similar applications. The system of the present invention engages multiple lifting points on the structure, such that vertical motion of the structure can be achieved by lifting or lowering movement applied thereto by the system.

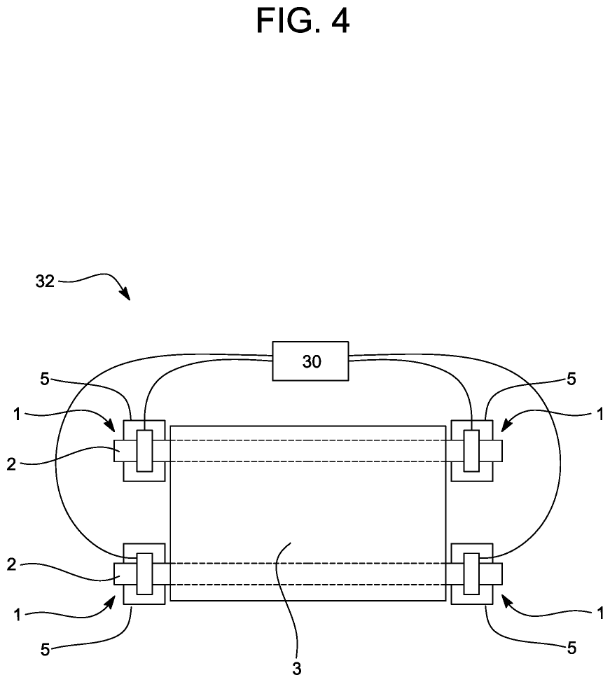

The system of the present invention comprises a plurality of lifting towers, one lifting tower for each engagement point which it is desired to lift on the structure. Referring for example to FIG. 4 there is shown a schematic demonstrating a system comprising four lifting towers 1 engaging to lifting beams 2 placed under a structure 3. Each lifting tower 1 engages a particular engagement point 2A of a lifting beam 2. From the perspective of embodiments of the system of the present invention, it will be understood to those skilled in the art that different numbers of attachment points or engagement points might be required to raise or lower a particular structure, and a system comprising the necessary number of lifting towers 1 to engage in any number of engagement points 2A are all contemplated within the scope of the present invention.

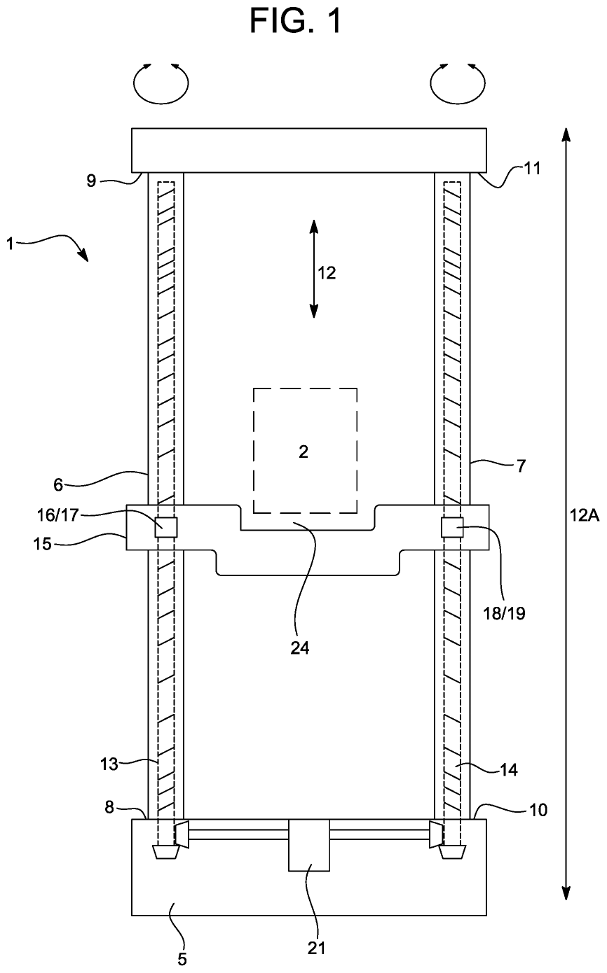

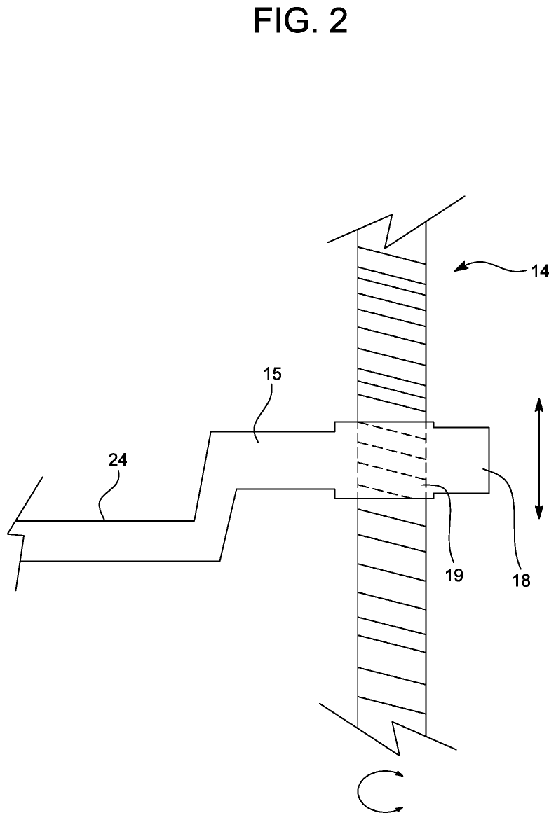

Referring to the lifting tower 1 itself, FIGS. 1 and 2 demonstrate a first embodiment of a lifting tower 1. The lifting tower 1 includes a ground engaging base 5. The base 5 will engage the ground beneath or in proximity to the structure to be lifted. The attachment of the base 5 to the remainder of the components of the lifting tower 1 could be rigid and fixed, or in other embodiments might permit for leveling or adjustment to be made, to allow for engagement of uneven ground are surfaces by the base 5 while still accommodating the vertical axial orientation of the remainder of the towers desired. Effectively, the attachment of the base 5 and the remainder of the components of the tower 1 will accommodate engaging the ground or other surface in proximity to the structure to be lifted and will permit for the approximately vertical axial orientation desired of the remainder of the tower 1—wherein the tower will effectively extend axially upwardly from the ground or surface in parallel to the direction in which it is desired to move the structure. Either embodiment, namely that of a rigid attachment between the base and the remainder of the tower, or a base attachment permitting for adjustment to fine tune the vertically axial orientation of the remainder of the tower 1 in relation to the structure will both be understood by those skilled in the art and are contemplated within the scope of the present invention.

In addition to the base 5 the lifting tower 1 comprises the left column 6 in the right column 7 extending vertically upwards from the base 5. The left column 6 has a base end 8 and a top end 9. The base end 8 is attached to the base 5. As outlined above, the base end 8 might be attached rigidly to the base 5 are might be attached in a way that it could be adjusted to fine tune the vertical orientation of the column 6, or even for example to permit for strike down or folding of the base in relation to the remainder of the tower for storage and transport.

Similar to the left column 6, the right column 7 has a base end 10 and a top end 11. The base end 10 of the right column 7 is also attached to the base 5, extending approximately vertically are perpendicular upwards therefrom and parallel to the left column 6 such that the left column 6 on the right column 7 define a travel zone 12 between them and therealong, extending approximately from the base 5 to the top ends 9, 11. The travel zone 12 is effectively the stroke of the tower 1, defining the full range of vertical motion which can be applied to the engaged structure without the need for interim recalibration or reset.

As outlined above, where the structure to be lifted or lowered is positioned on ground or surface that is fairly flat, the columns 6, 7 could simply extend perpendicular upwards from the base 5, or in other cases it may be desirable to render them adjustable in relation to the base 5—the left and right columns 6, 7 of the tower need to extend upwards approximately parallel to the axis or direction in which it is desired to lift the engaged structure.

In addition to the left column 6 in the right column 7 attached to the base 5, the lifting tower 1 also includes a mirrored pair of lifting rods. Specifically, a threaded left lifting rod 13 of at least the same length as the left column 6 is rotatably attached to the tower 1 in parallel axial relation to the left column 6—ie. the threaded left lifting rod 13 is attached parallel to the axially/substantially vertical orientation of the left column 6, and is rotatably attached to the tower 1 such that it can be rotated around its vertical axis upon the application of rotary power. Similarly, a threaded right lifting rod 14 of at least the same length as the right column 7 is also rotatably attached to the tower 1, in parallel axial relation to the right column 7—i.e. the threaded right lifting rod 14 is attached parallel to the axially/substantially vertical orientation of the right column 7 and is rotatably attached to the tower 1 such that it can be rotated around its vertical axis upon the application of rotary power. Rotary attachment of the threaded rods 13, 14 to the tower 1 is likely made at the base 5 outside of the travel zone 12, and could be reinforced by the provision of a bracket or other holding means at or near the top ends of the corresponding columns 6, 7 to maintain the vertical orientation of the rods 13, 14. With the threaded rods 13 and 14 being of at least the same length as their corresponding columns 6 and 7, each of the threaded rods 13 and 14 provides a “climbable” threaded surface for engagement such that a threaded collar engaging either rod 13 or 14 will effectively rise or decline along the body of the corresponding rod 13 or 14 upon the application of rotary power thereto. In other embodiments, the Rotary attachment of the threaded rod 13 and 14 to the columns 6 and 7 could be driven and/or made at or near the top end of the columns 6 and 7.

The lifting tower 1 also includes a travelling lift 15 positioned between and engaging the left and right columns 6 and 7. The travelling lift 15 is capable of travel along the left and right columns 6 and 7 within the travel zone 12. The body of the travelling lift 15 would include a left column engagement means 16 which extends outside of the left column 6 and comprises a left threaded collar 17 which is aligned parallel to the base 5 and is fixedly attached to the body of the lift 15, defining a threaded aperture through which the left threaded rod 13 extends. The body of the travelling lift 15 also includes a right column engagement means 18 which extends outside of the right column 7 comprises a right threaded collar 19 which is aligned parallel to the base 5 and fixedly attached to the body of the lift 15, defining a threaded aperture through which the right threaded rod 14 extends.

The body of the travelling lift 15 also includes an engagement interface 24 engagement of the lift 15 to an engagement point of the structure which it is desired to raise or lower using the system and lifting tower 1. As will be discussed further below, the engagement interface 24 could be a saddle for engaging the lower surface of a lifting beam inserted below the structure, or in other embodiments could comprise attachment hardware for the rigid attachment of the tower 1 to the structure to be lifted.

Finally, the lifting tower 1 also includes bidirectional rotational power means 21 for the application of mirrored rotational power to the left and right lifting rods 13 and 14. The rotational power means 21 likely comprises a hydraulic motor with appropriate gearing or other drive components although could be other types of rotational power means as well which will be understood to those skilled in the art.

The rotational power means 21 will engage the left and right lifting rods 13 and 14 such that when actuated, the rotational power means 21 will apply mirrored rotation to the left and right lifting rods 13 and 14. The left and right lifting rods 13 and 14 will rotate, in their rotatable connection to the base 5 and the remainder of the tower 1 such that the travelling lift 15 will climb or descend the left and right lifting rods 13 and 14 by operation of the threaded engagement of the rods 13 and 14 with the collars 17 and 19. By applying mirrored power to both the left and right sides of the travelling lift 15, the most evenly powered transitional motion will be applied to the movement of the structure.

The rotational power means 21 used will be locked when not actuated. This could be done either by simple virtue of the fact that the mechanical interface of the rotational power means 21 through to the travelling lift 15 will not permit gravitational movement of the lift 15 when the rotational power means 21 is not activated, or a specific physical locking mechanism could also be used. Both such approaches are contemplated within the scope of the present invention.

The travelling lift 15 can travel within the entire travel zone 12 defined by the columns 6 and 7 in a single stroke without the need for any intermediate recalibration of the tower 1 during the lifting of the structure engaged.

FIG. 2 is a detailed view of the operation of the lifting mechanism of the tower 1 and specifically in reference to a left column 6. It will be understood that many different types of lifting mechanisms and interfaces between a rotary power source and a threaded lifting interface such as is disclosed will all be possible and understood to those skilled in the art and all are contemplated within the scope of the present invention.

As disclosed in the claims and elsewhere herein, it is also specifically contemplated that the length of the columns 6 and 7 could be adjustable to permit the extension of the stroke and length of the travel zone 12 without the need to recalibrate any of the components of the lift during the lifting of the structuring question. It is specifically contemplated for example that the left and right columns 6 and 7 could comprise nested column sections, capable of telescoping to permit lengthening of the columns 6 and 7 during operation.

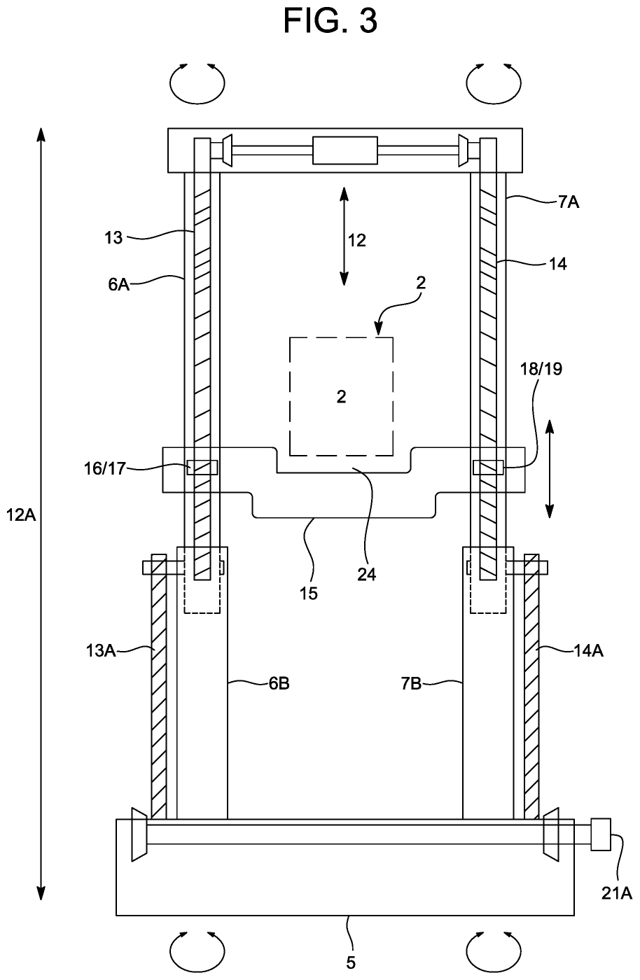

Referring to FIG. 3 there is shown an embodiment of the lifting tower 1 in which the left column 6 comprises an inner column section 6A and an outer column section 6B nested together and engaging each other in a way that the inner column section 6A can be extended upwards in relation to the base 5. Similarly, the right column 7 comprises an inner column section 7A and an outer column section 7B nested together and engaging each other in a way that the combined length of the right column 7 can be extended in operation of the tower 1. It is specifically contemplated that in a telescoping tower embodiments such as that shown in FIG. 7, the telescoping extension of the overall length of either of the columns 6 or 7 could be achieved using a second threaded rod and rotational power means, such as is used in the embodiment of FIG. 2 to provide the building lifting movement of the tower 1, whereby the second threaded rod and rotational power means could be actuated during lifting of the structure to extend the length of the related column 6 or 7. The rotational power means used to telescope the nested sections of the columns could be mirrored in control also, so that the same lifting or lowering motion is applied to both the left and right nested column sections. Providing the ability to nest column sections and extend them in a telescoping motion, such that the overall length of the column 6 and 7 could be extended in operation of the lifting motion of the tower 1 will be understood by those skilled in the art to be possible in many different means of manufacturer and all are contemplated again within the scope of the present invention. The rotary drive means 21 includes the motor itself as well as the necessary shaft, gearing and the like as might be acquired to connect the motor 21 to rotatably engage the necessary threaded rods.

In the tower 1 of FIG. 3, a secondary rotary drive means 21A is shown, in operative communication with secondary threaded rod sections 13A and 14A which can be seen to be used to elevate and telescope the length of the tower 1. Rotary drive 21A would apply mirrored rotary power to rods 13A and 14A to telescope the nested sections of the columns 6 and 7. Specifics of different means of telescoping the columns in nested sections 6 and 7 will be understood to those skilled in the art and all are contemplated within the scope of the present invention.

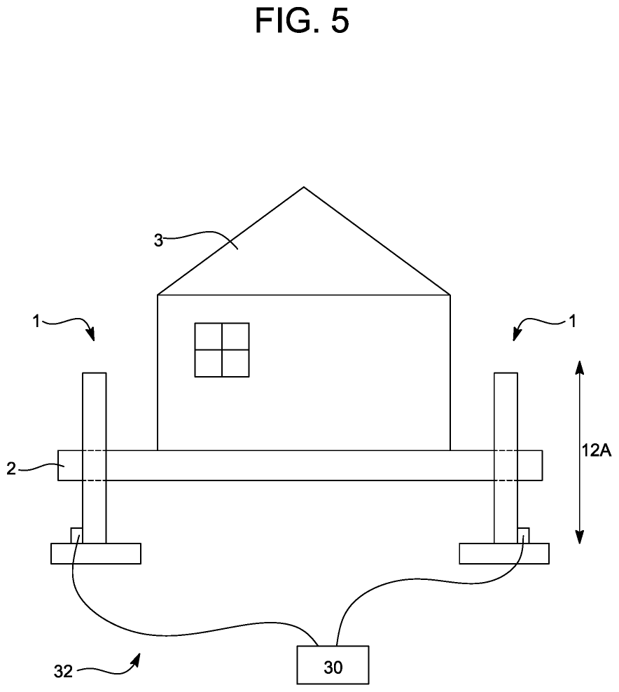

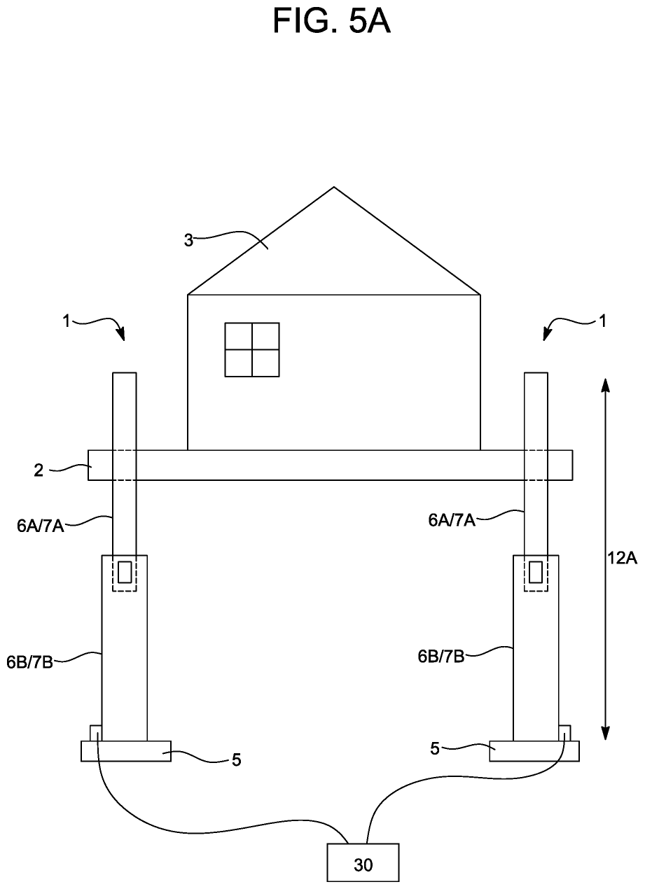

As outlined above, the lifting tower 1 of the present invention would be a component of a system 32 as shown in FIG. 4. The system 32 in this case comprises four lifting towers 1, each of which is engaging the lower engagement surface one end of a lifting beam 2 positioned below a structure 3. FIG. 5 is a side view demonstrating the attachment of the system of the present invention to a structure, as disclosed in the schematic of FIG. 4.

Also shown in FIG. 4 is a controller 30. The controller 30 could be used jointly control and actuate the rotary power means 21 of each of the towers 1. By jointly controlling all of the towers 1, actuation of the system 32 during the lifting of the structure is further simplified—effectively, beyond calibrating the level of the system in relation to the ground and the structure, in addition to mirrored vertical movement being applied to each of the threaded rods of each tower, if the rotary power means 21 are all geared or powered the same, each threaded rod of each tower 1 will rotate at the same speed and provide approximately equal movement at each engagement point of the structure at the same time.

It will also be understood that the towers 1 of the present invention could be individually actuated in another embodiment without the controller 30 and is also contemplated within the scope of the present invention.

FIGS. 5 and 5A are side views of two embodiments of the system 32 in accordance with the present invention, demonstrating the lifting of a structure 3. The system 32 of FIG. 5 shows the range of movement in the travel zone 12, shown at 12A, effectively being the stroke or the complete length of the travel zone 12 representing the lifting distance that can be achieved by the towers 1 and the system 32. The system shown in FIG. 5A shows telescoping towers 1, for the purpose of demonstrating the higher lifting range being achieved by lengthening the stroke 12A by extending nested telescoping sections of each column 6 and 7 to extend the length of the towers 1 while lifting the body of the travelling lift 15 up along the length of the towers. In the embodiment of this Figure, the controller 30 is also shown to be connected to the actuators of the telescoping sections in addition to the rotary power means that the base 5. In a telescoping embodiment of the towers 1 it is effectively contemplated that the travelling lift 15 would travel in relation to the innermost nested column section, while the innermost column section itself could be lifted in relation to the outermost section to lengthen it.

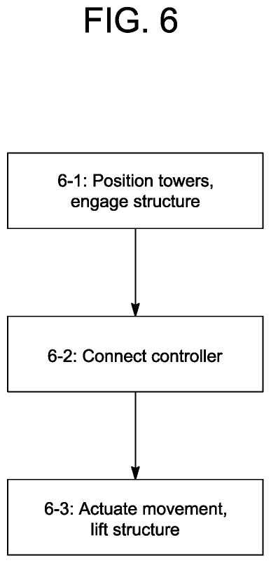

Finally, FIG. 6 is a flowchart showing the steps in one embodiment of a method in accordance with the present invention which effectively comprises the steps of lifting a structure using a plurality of lifting towers 1 such as are outlined herein. The steps of the method comprise first positioning a plurality of lifting towers each to engage in engagement point of the structure to which lifting or lowering forces to be applied. Positioning of the lifting towers is shown at step 6-1. The lifting towers could be any embodiment of the lifting tower in accordance with the remainder of the claims in the present invention outlined herein.

Each lifting tower would be positioned, at step 6-1, to engage an engagement point of the structure. In the examples of the lifting towers which comprise a saddle as the travelling lift, for use in conjunction with lifting beams underneath the structure, the lifting tower could be positioned with the end of the lifting being placed therein and engaging the bottom surface of the beam with the upper surface of the saddle. In other embodiments, where rigid or fixed attachment is contemplated, each lifting tower could be attached with lifting hardware to the attachment point of the structure. Both such approaches are contemplated within the scope of the present invention.

Following the positioning of the plurality of lifting towers in relation to the structure, a controller would be connected to the power means of each lifting tower. Connection of the controller is shown at step 6-2.

Shown next at step 6-3, the controller once connected to the rotary power means of each lifting tower could be used to actuate the power means of one or more of the towers to lift the structure to the desired height by causing the travel of the travelling lift for each tower within the travel zone thereof.

In certain embodiments of the method, where the lifting towers are adjustable in height, the controller could also be used to adjust the height of the towers, to effectively lengthen the stroke or length of the travel zone without the need to disconnect the structure from the towers or to otherwise perform any interim calibration a reset on the towers during lifting of the structure.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. The terms “comprises” and “comprising” should be interpreted as referring to elements, components, or steps in a non-exclusive manner, indicating that the referenced elements, components, or steps may be present, or utilized, or combined with other elements, components, or steps not expressly referenced.

1: A lifting tower for use in the adjustment of the height of an attached structure, said tower comprising:
a) a ground-engaging base;
b) a left column having a base end and a top end, the base end being attached to the base and extending axially upwards therefrom;
c) a right column having a base end and a top end, the base end being attached to the base and extending axially upwards therefrom and parallel to the left column such that the left column and right column define a travel zone between them and therealong extending from the base to the top ends thereof;
d) a threaded left lifting rod of at least the same length as the left column, rotatably attached in parallel axial relation to the left column;
e) a threaded right lifting rod of at least the same length as the right column, rotatably attached in parallel axial relation to the right column;
f) a travelling lift positioned between and engaging the left and right columns and capable of travel therealong within the travel zone, said lift comprising:
a. a left column engagement means extending outside of the left column and comprising a left threaded collar aligned parallel to the base with the left threaded rod extending therethrough;
b. a right column engagement means extending outside of the right column and comprising a right threaded collar aligned parallel to the base with the right threaded rod extending therethrough; and
c. an engagement interface for engagement of the lift to an engagement point of the structure via which tower-generated vertical movement will be applied to the structure; and
g) bidirectional rotational power means for application of mirrored rotational power to the left and right lifting rods;
wherein actuation of the rotational power means will on rotation of the left and right threaded rods result in the application of lifting or lowering force to the lift and any attached structure;
wherein the rotational power means is locked when not actuated, eliminating gravitational movement of the lift; and
wherein the lift can travel within the entire travel zone defined by the columns in a single stroke without the need for any intermediate recalibration of the tower.

2: The lifting tower of claim 1 further comprising an upper terminating member joining the top ends of the columns and maintaining the parallel spacing of the columns and the width of the travel zone therebetween.

3: The lifting tower of claim 1 wherein the rotational power means comprises left and right motors attached in relation to the left and right threaded rods and having mirrored control.

4: The lifting tower of claim 1 wherein the rotational power means comprises a single motor with a means of providing mirrored rotational power from the single motor to both the left and right threaded rods.

5: The lifting tower of claim 1 wherein the engagement interface comprises a saddle for the engagement of a lifting beam placed underneath the structure.

6: The lifting tower of claim 1 wherein the engagement interface comprises engagement hardware for attachment to a structural engagement point of the structure itself.

7: The lifting tower of claim 1 wherein the rotational power means is located at the top end of the tower.

8: The lifting tower of claim 1 wherein the rotational power means is located at the base of the tower.

9: The lifting tower of claim 1 wherein the left column and right column are adjustable in length to permit adjustment of the length and travel distance of the travel zone.

10: The lifting tower of claim 9 wherein the left column and right column comprise telescoping sections to permit adjustment of the length thereof.

11: The lifting tower of claim 10 further comprising powered extension means to mechanically telescope the length of the columns without the need for detachment of the tower from the structure.

12: A system for use in the lifting of a structure by applying lifting force to a plurality of engagement points of the structure, said system comprising:
a. a plurality of lifting towers corresponding to the number of engagement points of the structure to which lifting or lowering force is to be applied, each lifting tower comprising:
i. a vertical tower body;
ii. a lift for engagement of a corresponding engagement point of the structure and being attached to the vertical tower body for vertical movement within a travel zone defined by the tower body, wherein the lift can travel within the entire travel zone in a single stroke without the need for any intermediate recalibration of the tower; and
iii. power means capable of applying lifting or lowering movement to the lift when actuated, and being locked to restrict gravitational movement of the lift when not actuated; and
b. a controller connected to the power means of each lifting tower and capable of independently controlling the lifting movement applied to the structure by each tower.

13: The system of claim 12 wherein the lifting towers are of a fixed height.

14: The system of claim 12 wherein the lifting towers are adjustable in height.

15: The system of claim 12 wherein the lifting towers each comprise:
a. a ground-engaging base;
b. a left column having a base end and a top end, the base end being attached to the base and extending axially upwards therefrom;
c. a right column having a base end and a top end, the base end being attached to the base and extending axially upwards therefrom and parallel to the left column such that the left column and right column define a travel zone between them and therealong extending from the base to the top ends thereof;
d. a threaded left lifting rod of at least the same length as the left column, rotatably attached in parallel axial relation to the left column;
e. a threaded right lifting rod of at least the same length as the right column, rotatably attached in parallel axial relation to the right column;
f. a travelling lift positioned between and engaging the left and right columns and capable of travel therealong within the travel zone, said lift comprising:
a. a left column engagement means extending outside of the left column and comprising a left threaded collar aligned parallel to the base with the left threaded rod extending therethrough;
b. a right column engagement means extending outside of the right column and comprising a right threaded collar aligned parallel to the base with the right threaded rod extending therethrough; and
c. an engagement interface for engagement of the lift to an engagement point of the structure via which tower-generated vertical movement will be applied to the structure; and
g. bidirectional rotational power means for application of mirrored rotational power to the left and right lifting rods;
wherein actuation of the rotational power means will result in the application of lifting or lowering force to the lift and any attached structure;
wherein the rotational power means is locked when not actuated, eliminating gravitational movement of the lift; and
wherein the lift can travel within the entire travel zone defined by the columns in a single stroke without the need for any intermediate recalibration of the tower.

16. (canceled)

17: A method of lifting of a structure by applying lifting force to a plurality of engagement points of the structure, said method comprising:
a. positioning a plurality of lifting towers each to an engagement point of the structure to which lifting or lowering force is to be applied, each lifting tower comprising:
i. a vertical tower body;
ii. a lift for engagement of a corresponding engagement point of the structure and being attached to the vertical tower body for vertical movement within a travel zone defined by the tower body, wherein the lift can travel within the entire travel zone in a single stroke without the need for any intermediate recalibration of the tower; and
iii. power means capable of applying lifting or lowering movement to the lift when actuated, and being locked to restrict gravitational movement of the lift when not actuated;
b. connecting a controller to the power means of each lifting tower and capable of independently controlling the lifting movement applied to the structure by each tower; and
c. using the controller, actuating the power means of one or more of the towers to lift the structure to the desired height.

18: The method of claim 17 wherein the lifting towers are of a fixed height.

19: The method of claim 17 wherein the lifting towers are adjustable in height.

20: The method of claim 17 wherein the lifting towers each comprise:
a. a ground-engaging base;
b. a left column having a base end and a top end, the base end being attached to the base and extending axially upwards therefrom;
c. a right column having a base end and a top end, the base end being attached to the base and extending axially upwards therefrom and parallel to the left column such that the left column and right column define a travel zone between them and therealong extending from the base to the top ends thereof;
d. a threaded left lifting rod of at least the same length as the left column, rotatably attached in parallel axial relation to the left column;
e. a threaded right lifting rod of at least the same length as the right column, rotatably attached in parallel axial relation to the right column;
f. a travelling lift positioned between and engaging the left and right columns and capable of travel therealong within the travel zone, said lift comprising:
d. a left column engagement means extending outside of the left column and comprising a left threaded collar aligned parallel to and fixedly attached to the base with the left threaded rod extending therethrough;
e. a right column engagement means extending outside of the right column and comprising a right threaded collar aligned parallel to and fixedly attached to the base with the right threaded rod extending therethrough; and
f. an engagement interface for engagement of the lift to an engagement point of the structure via which tower-generated vertical movement will be applied to the structure; and
g. bidirectional rotational power means for application of mirrored rotational power to the left and right lifting rods.

21: The method of claim 17 wherein a plurality of beams is temporarily installed under the structure to lift same, the engagement interfaces comprise saddles for engaging the beams, and the engagement points of the structure are surfaces of the beams engaging the saddles.

22: The method of claim 19 wherein the height of the towers is mechanically adjusted during the lifting of the structure.
